(19) United States
(12) Patent Application Publication
(10) Pub. No.: US 2024/0182072 A1
(43) Pub. Date: Jun. 6, 2024

(54) AUTONOMOUS DRIVING APPARATUS AND AUTONOMOUS DRIVING CONTROL METHOD

(71) Applicant: HL KLEMOVE CORP., Incheon (KR)

(72) Inventor: Sangkyun SIM, Gyeonggi-do (KR)

(21) Appl. No.: 18/380,659

(22) Filed: Oct. 17, 2023

(30) Foreign Application Priority Data
Dec. 5, 2022 (KR) 10-2022-0167800

(51) Int. Cl. B60W 60/00; B60W 50/00

(52) U.S. Cl. CPC B60W 60/0016; B60W 50/00; B60W 2420/42; B60W 2420/52; B60W 2520/00; B60W 2540/30; B60W 2554/80

(57) ABSTRACT

Disclosed herein is an autonomous driving apparatus including an external camera having a field of view around a vehicle and configured to acquire image data, a radar having a field of sensing around the vehicle and configured to acquire radar data, and a controller configured to determine whether a control authority transfer condition of the vehicle is satisfied based on at least one of the image data or the radar data during autonomous driving of the vehicle, wherein the controller determines whether the vehicle normally drives based on at least one of the image data or the radar data, determines that the control authority transfer condition is satisfied when the driving of the vehicle is in an abnormal state, and transfers a control authority to a pre-registered remote controller when the control authority transfer condition is satisfied.

### CROSS-REFERENCE TO RELATED APPLICATION

This application claims the benefit of Korean Patent Application No. 10-2022-0167800, filed on Dec. 5, 2022 in the Korean Intellectual Property Office, the disclosure of which is incorporated herein by reference.

### BACKGROUND

### 1. Field

Embodiments of the present disclosure relate to an autonomous driving apparatus and an autonomous driving control method, and more specifically, to an autonomous driving apparatus and an autonomous driving control method capable of transferring a control authority of a vehicle according to situations.

### 2. Description of the Related Art

Vehicles are the most common transportation in modern society, and the number of people using the vehicles is increasing. Although there are advantages such as easy long-distance driving and convenience of living with the development of a vehicle technology, a problem that road traffic conditions deteriorate and traffic congestion becomes serious in densely populated places such as Korea often occurs.

Recently, research on vehicles equipped with an advanced driver assist system (ADAS) for actively providing information on a vehicle state, a driver state, or a surrounding environment in order to reduce a driver's burden and enhance convenience is actively progressed.

As examples of ADASs mounted on vehicles, there are lane departure warning (LDW), lane keeping assist (LKA), high beam assist (HBA), autonomous emergency braking (AEB), traffic sign recognition (TSR), adaptive cruise control (ACC), blind spot detection (BSD), etc.

An ADAS may collect information on the surrounding environment and process the collected information. In addition, the ADAS may recognize objects and design a route through which a vehicle drives based on a result of processing the collected information, and the vehicle may perform autonomous driving using the ADAS.

### SUMMARY

Therefore, it is an aspect of the present disclosure to provide an autonomous driving apparatus and an autonomous driving control method capable of appropriately transferring a control authority based on various pieces of information such as a driver's state, a driving state of a vehicle, and an autonomous driving situation.

Additional aspects of the disclosure will be set forth in part in the description which follows and, in part, will be obvious from the description, or may be learned by practice of the disclosure.

In accordance with one aspect of the present disclosure, an autonomous driving apparatus includes an external camera having a field of view around a vehicle and configured to acquire image data, a radar having a field of sensing around the vehicle and configured to acquire radar data, and a controller configured to determine whether a control authority transfer condition of the vehicle is satisfied based on at least one of the image data or the radar data during autonomous driving of the vehicle, wherein the controller determines whether the vehicle normally drives based on at least one of the image data or the radar data, determines that the control authority transfer condition is satisfied when the driving of the vehicle is in an abnormal state, and transfers a control authority to a pre-registered remote controller when the control authority transfer condition is satisfied.

The controller may determine whether the vehicle departs from a lane based on the image data and determine that the driving of the vehicle is abnormal when the vehicle departs from the lane.

The controller may determine a degree of risk of collision between the vehicle and a nearby vehicle based on at least one of the radar data or the image data, and when the degree of risk of collision exceeds a reference level, determine that the driving of the vehicle is abnormal.

The autonomous driving apparatus may further include a light detection and ranging (LiDAR) having a field of sensing around the vehicle to acquire LiDAR data, wherein the controller may determine a degree of risk of collision between the vehicle and a nearby vehicle based on at least one of the LiDAR data or the image data, and when the degree of risk of collision exceeds a reference level, determine that the driving of the vehicle is abnormal.

The controller may determine whether the vehicle is suddenly steered based on an output of a steering angle sensor provided in the vehicle, and when the vehicle is suddenly steered, determine that the driving of the vehicle is abnormal.

The controller may determine a control authority return condition based on at least one of the image data or the radar data, and when the control authority return condition is satisfied, transfer the control authority from the remote controller to the vehicle.

The control authority transfer condition may further include at least one of a driver's abnormal state of the vehicle or a limit situation of the autonomous driving.

The controller may determine the driver's abnormal state based on an output of at least one of an internal camera provided in the vehicle to capture the driver or a driver sensor configured to acquire biosignals of the driver.

The controller may transfer the control authority to the pre-registered remote controller when the driving of the vehicle is abnormal and there is no response from the driver of the vehicle.

In accordance with another aspect of the present disclosure, an autonomous driving apparatus includes at least one memory configured to store a program for autonomous driving of a vehicle, and at least one processor configured to execute the stored program, wherein the processor determines whether the vehicle normally drives based on at least one of image data acquired by an external camera provided in the vehicle, radar data acquired by a radar provided in the vehicle, or LiDAR data acquired by a LiDAR provided in the vehicle, determines that a control authority transfer condition of the vehicle is satisfied when the driving of the vehicle is abnormal, and transfers a control authority to a pre-registered remote controller when the control authority transfer condition is satisfied.

The processor may determine whether the vehicle departs from a lane based on the image data and determine that the driving of the vehicle is abnormal when the vehicle departs from the lane.

The processor may determine a degree of risk of collision between the vehicle and a nearby vehicle based on at least one of the radar data, the image data, or the LiDAR data, and when the degree of risk of collision exceeds a reference level, determine that the driving of the vehicle is abnormal.

The processor may determine whether the vehicle is suddenly steered based on an output of a steering angle sensor provided in the vehicle, and when the vehicle is suddenly steered, determine that the driving of the vehicle is abnormal.

The processor may determine a control authority return condition based on at least one of the image data, the LiDAR data, or the radar data, and when the control authority return condition is satisfied, transfer the control authority from the remote controller to the vehicle.

The control authority transfer condition may further include at least one of a driver's abnormal state of the vehicle or a limit situation of the autonomous driving.

The controller may determine the driver's abnormal state based on an output of at least one of an internal camera provided in the vehicle to capture the driver or a driver sensor configured to acquire biosignals of the driver.

The controller may transfer the control authority to the pre-registered remote controller when the driving of the vehicle is abnormal and there is no response from the driver of the vehicle.

In accordance with still another aspect of the present disclosure, an autonomous driving control method includes acquiring image data through an external camera provided in a vehicle, acquiring radar data through a radar provided in the vehicle, determining whether the vehicle normally drives based on at least one of the image data or the radar data during autonomous driving of the vehicle, determining that a control authority transfer condition is satisfied when the driving of the vehicle is abnormal, and transferring a control authority to a pre-registered remote controller when the control authority transfer condition is satisfied.

The determining of whether the vehicle normally drives may include determining whether the vehicle departs from a lane based on the image data and determining that the driving of the vehicle is abnormal when the vehicle departs from the lane.

The determining of whether the vehicle normally drives may include determining a degree of risk of collision between the vehicle and a nearby vehicle based on at least one of the radar data or the image data and determining that the driving of the vehicle is abnormal when the degree of risk of collision exceeds a reference level.

The autonomous driving control method may further include acquiring LIDAR data through an LiDAR provided in the vehicle, wherein the determining of whether the vehicle normally drives may include determining a degree of risk of collision between the vehicle and a nearby vehicle based on at least one of the LIDAR data or the image data and determining that the driving of the vehicle is abnormal when the degree of risk of collision exceeds a reference level.

The determining of whether the vehicle normally drives may include determining whether the vehicle is suddenly steered based on an output of a steering angle sensor provided in the vehicle and determining that the driving of the vehicle is abnormal when the vehicle is suddenly steered.

The method may further include determining the control authority return condition based on at least one of the image data or the radar data and transferring the control authority from the remote controller to the vehicle when the control authority return condition is satisfied.

The control authority return condition may further include at least one of a driver's abnormal state of the vehicle or a limit situation of the autonomous driving.

The method may further include acquiring at least one of an output of an internal camera provided in the vehicle to capture the driver or an output of a driver sensor configured to acquire biosignals of the driver and determining the driver's abnormal state based on the acquired output.

The transferring of the control authority to the pre-registered remote controller may include transferring the control authority to the remote controller when the driving of the vehicle is abnormal and there is no response from the driver of the vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a configuration of a vehicle according to one embodiment;

FIG. 2 is a view illustrating fields of view of a camera, a radar, and a light detection and ranging (LIDAR) included in an autonomous driving apparatus according to one embodiment;

FIG. 3 is a view illustrating the number of cases in which a control authority of a vehicle is transferred according to one embodiment;

FIG. 4 is a view illustrating the relationship between a vehicle equipped with an autonomous driving apparatus according to one embodiment and other external devices;

FIG. 5 is a flowchart illustrating an autonomous driving control method according to one embodiment;

FIGS. 6 and 7 are views illustrating examples of screens displayed on an electronic device that has received a control authority from a vehicle;

FIG. 8 is a view illustrating an example of a state of being monitored to determine a control authority transfer condition in the autonomous driving control method according to one embodiment; and

FIGS. 9 to 12 are views illustrating various conditions in which a control authority is transferred in a table in the autonomous driving control method according to one embodiment.

### DETAILED DESCRIPTION

The same reference numbers indicate the same components throughout the specification. The present specification does not describe all elements of embodiments, and general contents or overlapping contents between the embodiments in the technical field to which the disclosure pertains will be omitted.

Terms “unit, module, member, and block” used in the specification may be implemented as software or hardware, and according to the embodiments, a plurality of “units, modules, members, and blocks” may be implemented as one component or one “unit, module, member, and block” may also include a plurality of components.

Throughout the specification, when a certain portion is described as being “connected” to another, this includes not only a case of being directly connected thereto but also a case of being indirectly connected thereto, and the indirect connection includes connection through a wireless communication network.

In addition, when a certain portion is described as “including,” a certain component, this means further including other components rather than precluding other components unless especially stated otherwise.

Throughout the specification, when a certain member is described as being positioned “on” another, this includes both a case in which the certain member is in contact with another and a case in which other members are present between the two members.

Terms such as first and second are used to distinguish one component from another, and the components are not limited by the above-described terms.

A singular expression includes plural expressions unless the context clearly dictates otherwise.

In each operation, identification symbols are used for convenience of description, and the identification symbols do not describe the sequence of each operation, and each operation may be performed in a different sequence from the specified sequence unless a specific sequence is clearly described in context.

Hereinafter, embodiments of the present disclosure will be described with reference to the accompanying drawings.

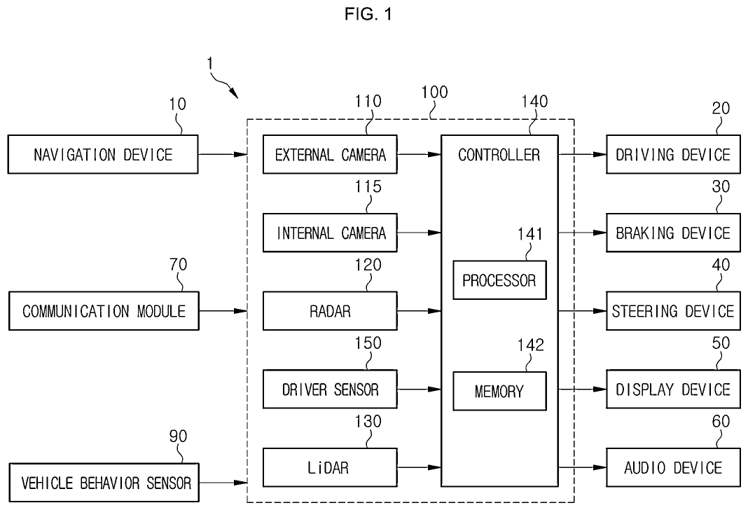

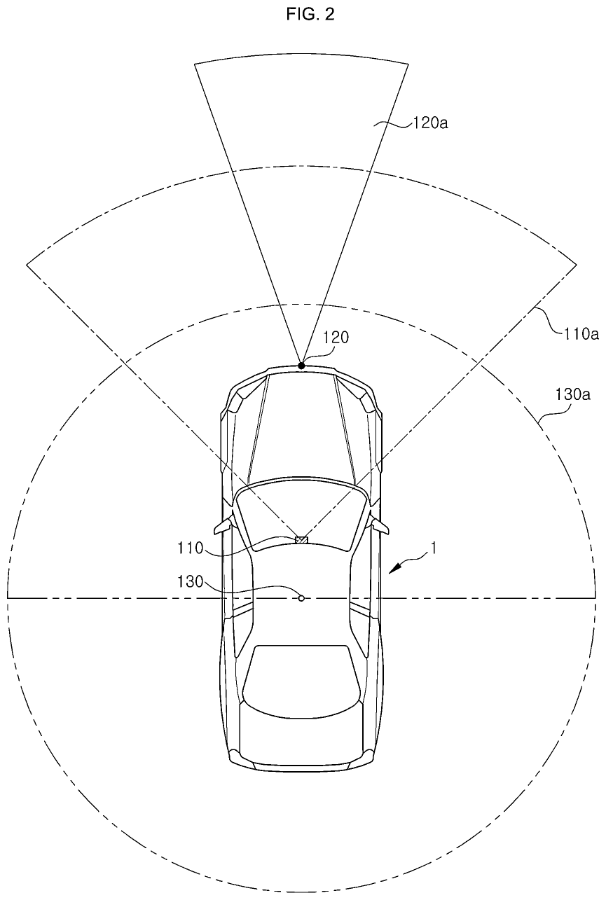

FIG. 1 is a view illustrating a configuration of a vehicle according to one embodiment, and FIG. 2 is a view illustrating fields of view of a camera, a radar, and a light detection and ranging (LiDAR) included in an autonomous driving apparatus according to one embodiment.

As illustrated in FIG. 1, a vehicle 1 may include a navigation device 10, a driving device 20, a braking device 30, a steering device 40, a display device 50, an audio device 60, and an autonomous driving apparatus 100.

In addition, the vehicle 1 may further include a vehicle behavior sensor 90 for detecting a dynamic of the vehicle 1. For example, the vehicle behavior sensor 90 may further include at least one of a vehicle speed sensor 91 for detecting a longitudinal speed of the vehicle 1, an acceleration sensor 92 for detecting a longitudinal acceleration and a transverse acceleration of the vehicle 1, or a gyro sensor 93 for detecting a yaw rate, a roll rate, or a pitch rate of the vehicle 1.

The navigation device 10, the driving device 20, the braking device 30, the steering device 40, the display device 50, the audio device 60, the vehicle behavior sensor 90, and the autonomous driving apparatus 100 may communicate with one another via a vehicle communication network. For example, the electric devices 10, 20, 30, 40, 50, 60, 90, and 100 included in the vehicle 1 may transmit or receive data via Ethernet, media oriented systems transport (MOST), Flexray, controller area network (CAN), local interconnect network (LIN), or the like.

The navigation device 10 may generate a route to a destination input by a driver and provide the generated route to the driver. The navigation device 10 may receive a global navigation satellite system (GNSS) signal from a GNSS and identify an absolute position (coordinates) of the vehicle 1 based on the GNSS signal. The navigation device 10 may generate the route to the destination based on the position (coordinates) of the destination input by the driver and a current position (coordinates) of the vehicle 1.

The navigation device 10 may provide map data and position information of the vehicle 1 to the autonomous driving apparatus 100. In addition, the navigation device 10 may provide information on the route to the destination to the autonomous driving apparatus 100. For example, the navigation device 10 may provide the autonomous driving apparatus 100 with information on a distance to an entry ramp for the vehicle 1 to enter a new road, a distance to an exit ramp for the vehicle 1 to exit from the road on which the vehicle 1 currently drives, etc.

The driving device 20 generates power required for moving the vehicle 1. The driving device 20 may include, for example, an engine, an engine management system (EMS), a transmission, and a transmission control unit (TCU).

The engine may generate power for the vehicle 1 to drive, and the EMS may control the engine in response to a driver's acceleration intention through an accelerator pedal or a request of the autonomous driving apparatus 100. The transmission may transmit the power generated by the engine to wheels for deceleration, and the TCU may control the transmission in response to a driver's transmission instruction through a transmission lever and/or a request of the autonomous driving apparatus 100.

Alternatively, the driving device 20 may also include a driving motor, a reducer, a battery, a power control device, etc. In this case, the vehicle 1 may be implemented as an electric vehicle.

Alternatively, the driving device 20 may also include both engine-related devices and driving motor-related devices. In this case, the vehicle 1 may be implemented as a hybrid electric vehicle.

The braking device 30 may stop the vehicle 1 and include, for example, a brake caliper and a brake control module (EBCM). The brake caliper may decelerate the vehicle 1 or stop the vehicle 1 using friction with a brake disk.

The EBCM may control the brake caliper in response to a driver's braking intention through a brake pedal or a request of the autonomous driving apparatus 100. For example, the EBCM may receive a deceleration request including a deceleration from the autonomous driving apparatus 100 and electrically or hydraulically control the brake caliper so that the vehicle 1 decelerates depending on the requested deceleration.

The steering device 40 may include an electronic power steering control module (EPS). The steering device 40 may change a driving direction of the vehicle 1, and the EPS may assist an operation of the steering device 40 so that the driver may easily manipulate a steering wheel in response to a driver's steering intention through a steering wheel.

In addition, the EPS may control the steering device 40 in response to a request of the autonomous driving apparatus 100. For example, the EPS may receive a steering request including a steering torque from the autonomous driving apparatus 100 and control the steering device 40 to steer the vehicle 1 based on the requested steering torque.

The display device 50 may include a cluster, a head-up display, a center fascia monitor, etc. and provide various pieces of information and entertainments to the driver through images and sounds. For example, the display device 50 may provide driving information of the vehicle 1, a warning message, etc. to the driver.

The audio device 60 may include a plurality of speakers and provide various pieces of information and entertainments to the driver through sounds. For example, the audio device 60 may provide driving information of the vehicle 1, a warning message, etc. to the driver.

The autonomous driving apparatus 100 may communicate with the navigation device 10, the vehicle behavior sensor 90, the driving device 20, the braking device 30, the steering device 40, the display device 50, and the audio device 60 via the vehicle communication network.

The autonomous driving apparatus 100 may receive the information on the route to the destination and the information on the position of the vehicle 1 from the navigation device 10 and receive the information on the vehicle speed, the acceleration, or the rates of the vehicle 1 from the vehicle behavior sensor 90.

The autonomous driving apparatus 100 may include an advanced driver assist system (ADAS) for providing various functions for a driver's safety. For example, the ADAS may provide functions of lane departure warning (LDW), lane keeping assist (LKA), high beam assist (HBA), autonomous emergency braking (AEB), traffic sign recognition (TSR), adaptive cruise control (ACC), blind spot detection (BSD), etc.

The autonomous driving apparatus 100 may include an external camera 110, a radar 120, a light detection and ranging (LiDAR) 130, and a controller 140. The external camera 110, the radar 120, the LiDAR 130, and the controller 140 may be physically provided separately from each other. For example, the controller 140 may be installed in a housing separated from a housing of the external camera 110, a housing of the radar 120, and a housing of the LiDAR 130. The controller 140 may exchange data with the external camera 110, the radar 120, or the LiDAR 130 through a wide-bandwidth network.

Alternatively, at least some of the external camera 110, the radar 120, the LIDAR 130, and the controller 140 may also be integrally provided. For example, the external camera 110 and the controller 140 may be provided in the same housing, the radar 120 and the controller 140 may be provided in the same housing, or the LIDAR 130 and the controller 140 may be provided in the same housing.

The external camera 110 may capture surroundings of the vehicle 1 and acquire image data of the surroundings of the vehicle 1. For example, as illustrated in FIG. 2, the external camera 110 may be installed on a front windshield of the vehicle 1 and may have a forward field of view 110a of the vehicle 1.

The external camera 110 may include a plurality of lenses and an image sensor. The image sensor may include a plurality of photodiodes for converting light into electrical signals, and the plurality of photodiodes may be disposed in the form of a two-dimensional matrix.

The image data may include information on another vehicle, a pedestrian, a cyclist, or a lane line (a marker for distinguishing a lane) positioned around the vehicle 1.

The autonomous driving apparatus 100 may include an image processor for processing the image data of the external camera 110, and the image processor may be, for example, integrally provided with the external camera 110 or integrally with the controller 140.

The image processor may acquire image data from the image sensor of the external camera 110 and detect and identify nearby objects of the vehicle 1 based on a result of processing the image data. For example, the image processor may generate tracks representing the nearby objects of the vehicle 1 using image processing and may classify the tracks. The image processor may identify whether the track is another vehicle, a pedestrian, or a cyclist, etc. and assign an identification code to the track.

The image processor may transmit data (or positions and classifications of the tracks) on tracks around the vehicle 1 (hereinafter referred to as “camera track”) to the controller 140.

The radar 120 may transmit transmission radio waves from the vehicle 1 toward surroundings and detect the nearby objects of the vehicle 1 based on reflection radio waves reflected from the nearby objects. For example, as illustrated in FIG. 2, the radar 120 may be installed on a grille or a bumper of the vehicle 1 and may have a rearward field of sensing 120a of the vehicle 1.

The radar 120 may include a transmission antenna (or a transmission antenna array) for radiating transmission radio waves from the vehicle 1 toward surroundings and a reception antenna (or a reception antenna array) for receiving reflection radio waves reflected from objects.

The radar 120 may acquire radar data from the transmission radio waves transmitted by the transmission antenna and the reflection radio waves received by the reception antenna. The radar data may include position information (e.g., distance information) or speed information of objects positioned in front of the vehicle 1.

The autonomous driving apparatus 100 may include a signal processor for processing the radar data of the radar 120, and the signal processor may be, for example, integrally provided with the radar 120 or integrally with the controller 140.

The signal processor may acquire the radar data from the reception antenna of the radar 120 and generate tracks representing the objects by clustering reflection points of a reflection signal. The signal processor may, for example, acquire a distance of the track based on a time difference between a transmission time of the transmission radio wave and a reception time of the reflection radio wave and acquire a relative speed of the track based on a difference between a frequency of the transmission radio wave and a frequency of the reflection radio wave.

The signal processor may transmit data (or the distances and relative speeds of the tracks) on the tracks around the vehicle 1 acquired from the radar data (hereinafter referred to as “radar track”) to the controller 140.

The LiDAR 130 may emit light (e.g., infrared rays) from the vehicle 1 toward surroundings and detect nearby objects of the vehicle 1 based on reflection light reflected from the nearby objects. For example, as illustrated in FIG. 2, the LiDAR 130 may be installed on a roof of the vehicle 1 and may have a field of view 130a of the vehicle 1 in all directions.

The LiDAR 130 may include a light source (e.g., a light emitting diode, a light emitting diode array, a laser diode, or a laser diode array) for emitting light (e.g., infrared rays) and an optical sensor (e.g., a photodiode or a photodiode array) for receiving light (e.g., infrared rays). In addition, as necessary, the LiDAR 130 may further include a driving device for rotating the light source or the optical sensor.

While the light source or the optical sensor rotates, the LiDAR 130 may emit light through the light source and receive the light reflected from objects through the optical sensor, thereby acquiring LiDAR data.

The LiDAR data may include relative positions (distances or directions of nearby objects) or relative speeds of the nearby objects of the vehicle 1.

The autonomous driving apparatus 100 may include a signal processor capable of processing the LiDAR data of the LiDAR 130, and the signal processor may be, for example, integrally provided with the LiDAR 130 or integrally with the controller 140.

The signal processor may generate tracks representing objects by clustering reflection points by the reflected light. The signal processor may, for example, acquire a distance to the object based on a time difference between a light transmission time and a light reception time. In addition, the signal processor may acquire a direction (or an angle) of the object with respect to a driving direction of the vehicle 1 based on a direction in which the light source emits light when the optical sensor receives the reflected light.

The signal processor may transmit data (or the distances and relative speeds of the tracks) on the tracks around the vehicle 1 acquired from the LiDAR data (hereinafter referred to as “LiDAR track”) to the controller 140.

The controller 140 may be implemented as at least one electronic control unit (ECU) or a domain control unit (DCU) electrically connected to the external camera 110, the radar 120, or the LiDAR 130. In addition, the controller 140 may be connected to other components of the vehicle 1, such as the navigation device 10, the driving device 20, the braking device 30, the steering device 40, the display device 50, the audio device 60, and the vehicle behavior sensor 90 via the vehicle communication network.

The controller 140 may process the camera track (or the image data) of the external camera 110, the radar track (or the radar data) of the radar 120, and the LiDAR track (or the LiDAR data) of the LiDAR 130 and provide control signals to the driving device 20, the braking device 30, or the steering device 40.

The controller 140 may include at least one memory 142 for storing a program for performing an operation to be described below and at least one processor 141 for executing the stored program.

In addition, the memory 142 may store programs or data for processing the image data, the radar data, or the LiDAR data. In addition, the memory 142 may store programs or data for generating driving, braking, and steering signals.

The memory 142 may temporarily store the image data received from the external camera 110, the radar data received from the radar 120, or the LiDAR data received from the LiDAR 130 and temporarily store a result of processing the image data, the radar data, or the LiDAR data of the processor 141.

In addition, the memory 142 may include a high definition (HD) map. Unlike general maps, the HD map may include detailed information on surfaces of roads or intersections, such as lane lines, traffic lights, intersections, and traffic signs. In particular, landmarks (e.g., lane lines, traffic lights, intersections, and traffic signs) that vehicles encounters while driving are implemented in a three dimension on the HD map.

The memory 142 may include both volatile memories such as a static random access memory (SRAM) and a dynamic RAM (DRAM) and non-volatile memories such as a read only memory (ROM) and an erasable programmable ROM (EPROM).

The processor 141 may process the camera track of the external camera 110, the radar track of the radar 120, or the LiDAR track of the LiDAR 130. For example, the processor 141 may fuse the camera track, the radar track, or the LIDAR track and output fusion data.

Based on a result of processing the fusion data, the processor 141 may generate a driving signal, a braking signal, or a steering signal for respectively controlling the driving device 20, the braking device 30, or the steering device 40. For example, the processor 141 may evaluate a risk of collision between the fusion tracks and the vehicle 1. The processor 141 may control the driving device 20, the braking device 30, or the steering device 40 to steer or brake the vehicle 1 based on the risk of collision between the fusion tracks and the vehicle 1.

The processor 141 may include the image processor for processing the image data of the external camera 110, the signal processor for processing the radar data of the radar 120, or a signal processor for processing the LiDAR data of the LIDAR 130, or a micro control unit (MCU) for generating the driving, braking, and steering signals.

As described above, the controller 140 may provide the driving signal, the braking signal, or the steering signal based on the image data of the external camera 110, the radar data of the radar 120, or the LiDAR data of the LiDAR 130.

A detailed operation of the autonomous driving apparatus 100 will be described in more detail below.

Meanwhile, the autonomous driving apparatus 100 according to one embodiment may further include an internal camera 115 provided inside the vehicle 1. The internal camera 115 may capture an interior of the vehicle 1.

For example, the internal camera 115 may be provided at a position at which a driver may be captured. A driver's image captured by the internal camera 115 may include information capable of determining the driver's abnormal state.

To this end, the internal camera 115 may be provided at a position at which at least one of a driver's face or a driver's upper body may be captured. In order to increase the accuracy of determination of the driver's abnormal state, a plurality of internal cameras 115 may also be provided, at least one of the plurality of internal cameras 115 may be provided at a position at which the driver's face, particularly, eyes may be captured, and at least another internal camera may be provided at a position at which a driver's attitude may be captured.

In addition, the autonomous driving apparatus 100 according to one embodiment may further include a driver sensor 150 capable of measuring data on the driver's state. For example, the driver sensor 150 may include at least one sensor capable of measuring biosignals such as a driver's heart rate, a driver's body temperature, and a driver's brain wave.

In addition, the vehicle 1 according to one embodiment may further include a communication module 70 capable of communicating with other external devices. The communication module 70 may wirelessly communicate with a base station or an access point (AP) and exchange data with external devices via the base station or the AP.

For example, the communication module 70 may wirelessly communicates with the AP using WiFi™ (IEEE 802.11 technical standard) or communicate with the base station using code division multiple access (CDMA), wideband CDMA (WCDMA), global system for mobiles (GSM), long term evolution (LTE), fifth generation (5G), wireless broadband Internet (WiBro), etc.

In addition, the communication module 70 may directly communicate with the external devices. For example, the communication module 70 may exchange data with short-range external devices using WiFi Direct, Bluetooth™ (IEEE 802.15.1 technical standard), ZigBee™ (IEEE 802.15.4 technical standard), etc.

Meanwhile, the components illustrated in FIG. 1 are not necessarily all included in the vehicle 1. For example, only one of the internal camera 115 and the driver sensor 150 may be provided, and the radar 120 or LiDAR 130 may be omitted and only the external camera 110 may be provided.

In addition, in the drawing, the internal camera 115, the external camera 110, and the driver sensor 150 are illustrated as one configuration of the autonomous driving apparatus 100, but the disclosed embodiment is not limited thereto.

Therefore, at least one of the internal camera 115, the external camera 110, or the driver sensor 150 may be provided in the vehicle 1 as a component independent of the autonomous driving apparatus 100, and the autonomous driving apparatus 100 may also acquire the image data or the biosignals from at least one of the internal camera 115, the external camera 110, or the driver sensor 150 provided in the vehicle 1.

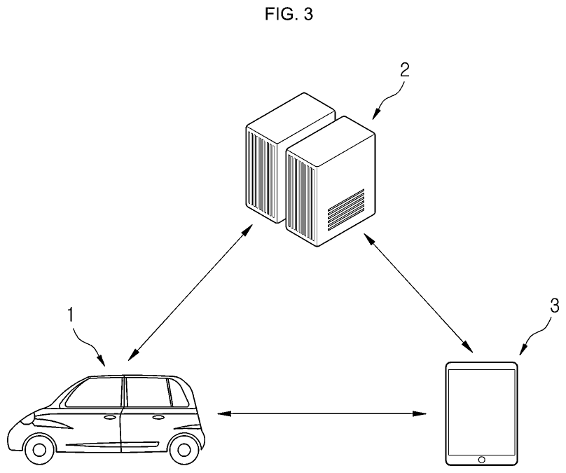

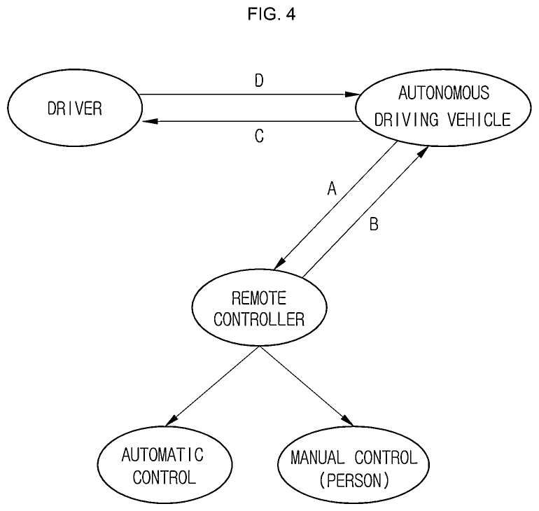

FIG. 3 is a view illustrating the number of cases in which a control authority of a vehicle is transferred according to one embodiment, and FIG. 4 is a view illustrating the relationship between a vehicle equipped with an autonomous driving apparatus according to one embodiment and other external devices.

As described above, the vehicle 1 may include the autonomous driving apparatus 100 and perform autonomous driving using the autonomous driving apparatus 100. However, a control authority of the vehicle 1 may be transferred to a pre-registered external remote controller according to a driver's state, a driver's request, a driving state of the vehicle 1, or the autonomous driving situation.

Referring to FIG. 3, when the driver transfers the control authority to the vehicle 1 (control authority transfer D), the vehicle 1 may perform autonomous driving. When performing the autonomous driving, the vehicle 1 may use a recognition result or a determination result of the autonomous driving apparatus 100.

It goes without saying that the control authority may be transferred from the vehicle 1 back to the driver by the driver's request or the determination of the vehicle 1 (control authority transfer C). Here, the determination of the vehicle 1 may mean the determination of the autonomous driving apparatus 100, more specifically, the determination of the controller 140.

As described above, the control authority of the vehicle 1 may also be transferred to the remote controller 3 (control authority transfer A). A description of a specific situation in which the control authority is transferred to the remote controller 3 will be described below.

The remote controller 3 to which the control authority is transferred may automatically control the vehicle 1, or the vehicle 1 may also be manually controlled by a user of the remote controller 3. In the case of automatically controlling the vehicle 1, an autonomous driving program may be installed in the remote controller 3. The remote controller 3 may receive various pieces of information acquired by the vehicle 1 and remotely and automatically control the vehicle 1 based on the provided information when the autonomous driving program is installed.

When a predetermined control authority return condition is satisfied, the control authority of the vehicle 1 may be transferred from the remote controller 3 back to the vehicle 1 (control authority transfer B). The control authority return condition will be described below again.

In order to transfer the above-described control authority, communication between the vehicle 1 and the remote controller 3 may be required, and a server 2 for relaying the communication between the vehicle 1 and the remote controller 3 or providing information required by the vehicle 1 or the remote controller 3 may be provided between the vehicle 1 and the remote controller 3.

Referring to FIG. 4, the vehicle 1 may exchange data while communicating with the server 2 and the remote controller 3, and based on such data transmission and reception, the control authority may be transferred between the vehicle 1 and the remote controller 3. The communication between the vehicle 1 and the server 2 or the remote controller 3 may be performed by the communication module 70.

For example, the transfer of the control authority of the vehicle 1 that is performing the autonomous driving may be determined by the vehicle 1. Specifically, the controller 140 may determine the driver's state, the driving state of the vehicle, or the autonomous driving situation based on at least one of the outputs of the external camera 110, the internal camera 115, the driver sensor 150, or the vehicle behavior sensor 90.

The controller 140 may determine whether to transfer the control authority according to the determination result and transmit a signal related to the transfer of the control authority to the remote controller 3 when it is determined to transfer the control authority to the remote controller 3. The vehicle 1 may directly transmit the signal related to the transfer of the control authority to the remote controller 3 or also transmit the signal to the remote controller 3 through the server 2.

As an example of remote control, a remote control application for remote control of the vehicle 1 may be installed in the remote controller 3. When the control authority is transferred from the vehicle 1 to the remote controller 3, the user of the remote controller 3 may remotely control the vehicle 1 after executing the remote control application. The remote control application may include the above-described autonomous driving program.

The remote controller 3 may be a mobile device such as a smart phone or a tablet PC. However, the disclosed embodiment is not limited thereto, and other electronic devices, which include communication modules such as a TV or a PC, display devices, and input devices, than the mobile device may become the remote controller 3 for remotely controlling the vehicle 1.

As another example, the transfer of control authority may also be determined by the server 2. In this case, the autonomous driving apparatus 100 may be included in the server 2, and the controller 140 among the above-described components of the autonomous driving apparatus 100 may be included in the server 2.

The output of the external camera 110, the internal camera 115, the driver sensor 150 or the vehicle behavior sensor 90 provided in the vehicle 1 may be transmitted to the server 2 through the communication module 70, and the server 2 may determine the driver's state, the driving state of the vehicle 1, or the autonomous driving situation based on the transmitted information.

The server 2 may determine whether to transfer the control authority according to the determination result and transmit a signal related to the transfer of the control authority to the remote controller 3 when it is determined to transfer the control authority to the remote controller 3.

Hereinafter, an autonomous driving control method according to one embodiment will be described. The autonomous driving control method according to one embodiment may be performed by at least one of the vehicle 1 or the server 2. Therefore, the above-described contents of the vehicle 1 and the server 2 may be applied to an embodiment of the autonomous driving control method in the same manner even when there is no separate mention.

Conversely, it goes without saying that the contents of the autonomous driving control method to be described below may also be applied to the embodiment of the vehicle 1 in the same manner even when there is no separate mention.

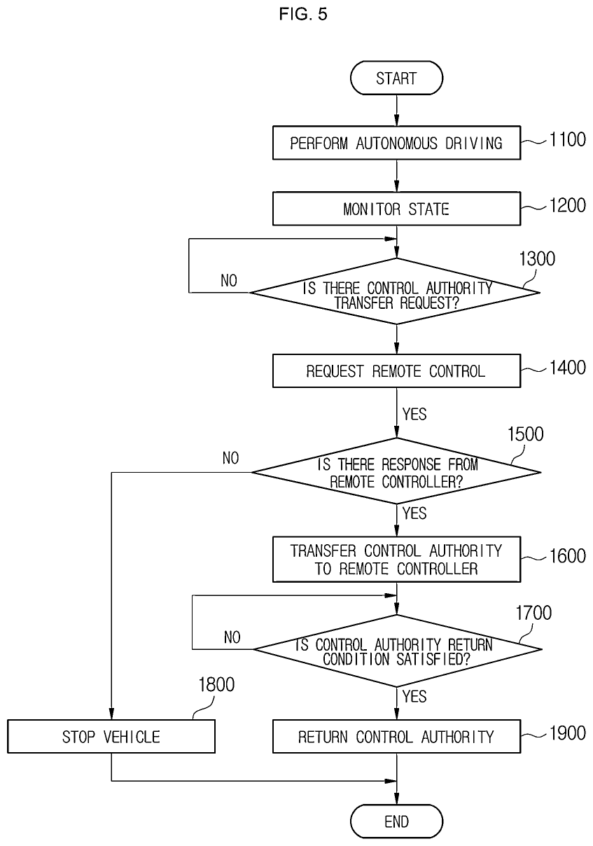

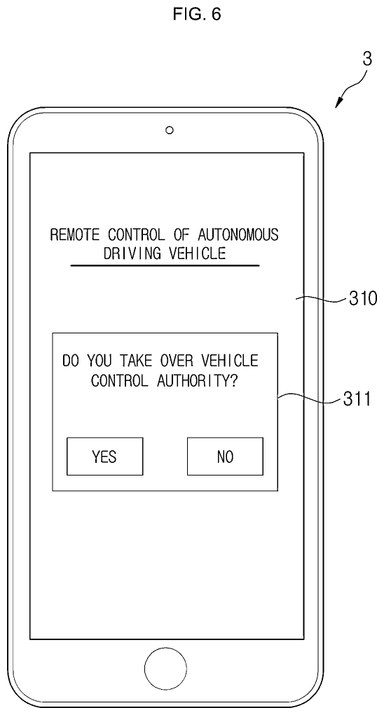

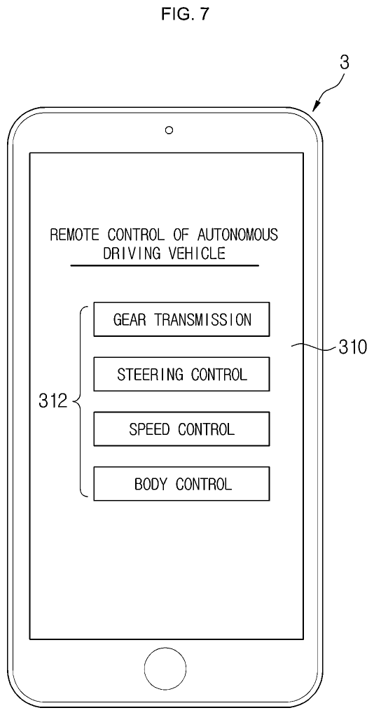

FIG. 5 is a flowchart illustrating an autonomous driving control method according to one embodiment, and FIGS. 6 and 7 are views illustrating examples of screens displayed on an electronic device that has received a control authority from a vehicle.

The vehicle 1 may be switched to an autonomous driving mode by a driver's request or satisfaction of an autonomous driving condition and may perform autonomous driving using the autonomous driving apparatus 100 (1100).

The vehicle 1 performing the autonomous driving may monitor a state based on outputs of various sensors and cameras (1200).

For example, the controller 140 may monitor the driver's state, the driving state of the vehicle, the autonomous driving situation, etc. A detailed description of the state monitored by the controller 140 will be described below.

Based on the monitoring result, the controller 140 may determine whether the control authority transfer condition is satisfied (1300), and when the control authority transfer condition is satisfied (YES in 1300), transmit a remote control request to the pre-registered remote controller 3 (1400).

At this time, signal transmission to the remote controller 3 may be directly performed by the vehicle 1 or may also be performed by the vehicle 1 through the server 2.

Referring to FIG. 6, a message 311 asking whether to transfer the control authority of the vehicle 1 may be displayed on a display 310 of the remote controller 3 that has received the remote control request.

The user of the remote controller 3 may take over the control authority of the vehicle 1 by selecting a “YES” button or reject the transfer of the control authority of the vehicle 1 by selecting a “NO” button.

The remote controller 3 to perform remote control may be matched for each vehicle 1. An identification number of the remote controller 3 may be matched with and stored in the vehicle 1, and the user of the remote controller 3 may execute the remote control application and access the vehicle 1 with an account matched with the vehicle 1 through an authentication procedure.

However, the disclosed embodiment is not limited to the above-described example, and any type of allowing an authorized electronic device to remotely control a specific vehicle may be included within the scope of the disclosed embodiment.

When the user of the remote controller 3 selects the “YES” button, that is, when a response is received from the remote controller 3 (YES in 1500), the control authority is transferred to the remote controller 3 (1600).

When the user of the remote controller 3 selects the “NO” button, that is, when the response is not received from the remote controller 3 (NO in 1500), the vehicle 1 may be stopped (1800). In addition, an emergency call may be made to a pre-designated target. Here, the pre-designated target may be an insurance company, a number designated by the driver, or a number for rescue request.

When the user selects the “YES” button and the control authority is transferred, as illustrated in FIG. 7, a menu 312 capable of performing gear transmission, steering control, speed control, or body control may be displayed on the display 310 of the remote controller 3.

The user of the remote controller 3 may manually control the vehicle 1 using an input device provided in the remote controller 3. The input device provided in the remote controller 3 may be integrally provided with the display 310 to implement a touch screen or may also be implemented as a separate button.

Alternatively, the remote controller 3 may also automatically perform the remote control of the vehicle 1. In this case, as described above, the autonomous driving program may be installed in the remote controller 3, and when the autonomous driving program is executed, the remote controller 3 may automatically perform the remote control of the vehicle 1 without user intervention.

Regardless of whether the remote controller 3 automatically or manually performs the remote control of the vehicle 1, the data acquired by various sensors and cameras of the vehicle 1 may be transmitted to the remote controller 3.

Specifically, the data acquired by the navigation device 10, the vehicle behavior sensor 90, the external camera 110, the internal camera 115, the LiDAR 130, and the driver sensor 150 may be transmitted to the remote controller 3.

The data transmitted to the remote controller 3 may be displayed on the display 310 to assist the user's manual control or may also be used as the basis of automatic control of the remote controller 3.

When the control authority return condition is satisfied while the remote controller 3 performs the remote control (YES in 1700), the control authority may be returned to the vehicle 1 (1900).

When the control authority is returned to the vehicle 1, the remote controller 3 may no longer perform the remote control, and the vehicle 1 may re-perform the autonomous driving, or the driver of the vehicle 1 may perform the manual driving.

The control authority return condition may correspond to the control authority transfer condition. Therefore, when the control authority transfer condition is no longer satisfied, the control authority return condition can be considered as being satisfied. Hereinafter, a detailed description thereof will be given.

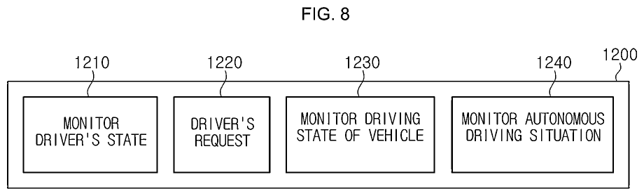

FIG. 8 is a view illustrating an example of a state of being monitored to determine a control authority transfer condition in the autonomous driving control method according to one embodiment.

The monitoring of the state (1200) may include monitoring the driver's state (1210), monitoring whether there is the driver's request (1220), monitoring the vehicle driving state (1230), and monitoring the autonomous driving situation (1240).

The controller 140 may monitor the driver's state based on the image data acquired from the internal camera 115 and the biosignals acquired from the driver sensor 150.

The controller 140 may determine the driver's abnormal state based on the image data acquired from the internal camera 115. For example, the controller 140 may detect a pupil from the image data, and determine whether the driver is conscious based on a result of detecting the pupil, or determine whether the driver is conscious based on a driver's motion or attitude determined from the image data. A driver's unconscious state may represent a case of dozing or falling, and in this case, it may be determined that the driver is in an abnormal state.

Alternatively, the controller 140 may also determine the driver's abnormal state based on the output of the driver sensor 150. A reference value that is a reference of determination of the abnormal state may be set for each type of the driver sensor 150, and when the output of the driver sensor 150 exceeds the set reference value, it may be determined that the driver is in the abnormal state.

When it is determined that the driver is in the abnormal state, the controller 140 may determine that the control authority transfer condition is satisfied.

In addition, the controller 140 may determine that the control authority transfer condition is satisfied even when the driver directly requests the transfer of the control authority. The driver may request the control authority transfer using various input devices provided in the vehicle 1.

For example, the driver may request the control authority transfer by manually manipulating the input device or also request the control authority transfer by inputting a voice instruction through a microphone.

In addition, the controller 140 may analyze a driving behavior of the vehicle 1 based on the output of the vehicle behavior sensor 90, the external camera 110, the radar 120, or the LiDAR 130 provided in the vehicle 1. Specifically, the controller 140 may determine whether the vehicle is suddenly steered, whether the vehicle departs from a lane, a degree of risk of collision with a nearby vehicle, etc. based on the outputs of the vehicle behavior sensor 90 and the external camera 110 and determine that the driving of the vehicle 1 is abnormal when the vehicle is suddenly steered, the vehicle departs from the lane, or the degree of risk of collision with the nearby vehicle exceeds a reference level.

For example, the vehicle behavior sensor 90 may include a steering angle sensor, and the controller 140 may determine whether the vehicle is suddenly steered based on an output of the steering angle sensor. Here, the sudden steering may mean that a direction of the vehicle 1 is rapidly changed, and the controller 140 may compare a change in a steering angle with a predetermined reference value and determine whether the vehicle is suddenly steered.

In addition, the controller 140 may determine whether the vehicle departs from the lane based on the output of the external camera 110, that is, the image data captured by the external camera 110.

In addition, the controller 140 may determine the degree of risk of collision with the nearby vehicle based on at least one of the radar data acquired from the radar 120, the image data acquired from the external camera 110, or the LiDAR data acquired from the LiDAR 130.

When it is determined that the driving of the vehicle 1 is in the abnormal state, the controller 140 may determine that the control authority transfer condition is satisfied.

In addition, the controller 140 may monitor the autonomous driving situation based on the vehicle behavior sensor 90 or the external camera provided in the vehicle 1, or a global positioning system (GSP) signal. For example, when lane information is not recognized or the GPS signal is not received, it may be determined to be the autonomous driving unavailability situation.

Alternatively, it may be also determined to be the autonomous driving unavailability situation when the sensors 91, 92, and 93, the external camera 11, etc. are out of order or may not perform normal functions because the sensors 91, 92, and 93, the external camera 11, etc. are covered by foreign substances or the like.

In addition, it may be determined to be the autonomous driving unavailability situation when an error of the position determination of the vehicle 1 or an error of the object recognition exceeds a reference level after monitoring performance of the autonomous driving apparatus 100 by various methods.

When it is determined to be the autonomous driving unavailability situation and the request for transfer of the control authority is made to the driver (control authority transfer C) but there is no response from the driver for a predetermined time or longer, it may be determined that the control authority transfer condition to the remote controller is satisfied.

The control authority transfer condition is not limited to the above-described examples, and the control authority may be transferred according to various conditions in addition to the above-described examples.

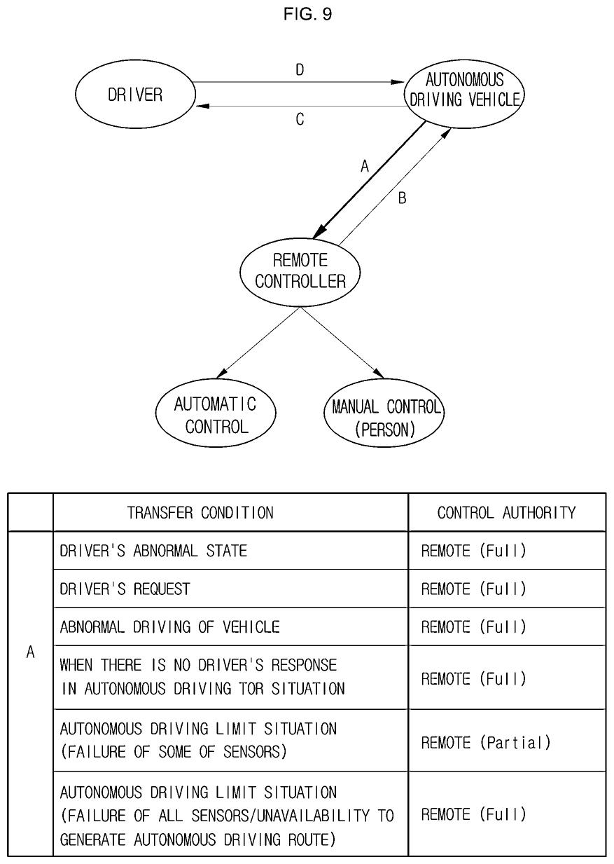

FIGS. 9 to 12 are views illustrating various conditions in which a control authority is transferred in a table in the autonomous driving control method according to one embodiment.

Referring to FIG. 9, a condition in which the control authority is transferred from the vehicle 1, which is performing the autonomous driving, to the remote controller 3 (control authority transfer A) may include the driver's abnormal state, the driver's request, the abnormal driving of the vehicle, autonomous driving limit situations, etc.

In addition, a driver's non-response may be included as an additional condition when the vehicle abnormally drives or is in the autonomous driving limit situation, and the control authority may be transferred to the remote controller 3 only when the driver does not respond.

In addition, the control authority may be also transferred back to the remote controller 3 when the driver does not respond in a take over request (TOR) situation in which the vehicle 1 that is performing the autonomous driving transfers the control authority back to the driver.

Meanwhile, in a situation in which some of the sensors involved in the autonomous driving are out of order in the autonomous driving limit situation, functions related to the normally operating sensor may be performed in the vehicle 1, and functions related to the failed sensor may be performed in the remote controller 3.

When all sensors involved in the autonomous driving are out of order, autonomous driving routes may not be generated, etc., the entire control authority may be transferred to the remote controller 3.

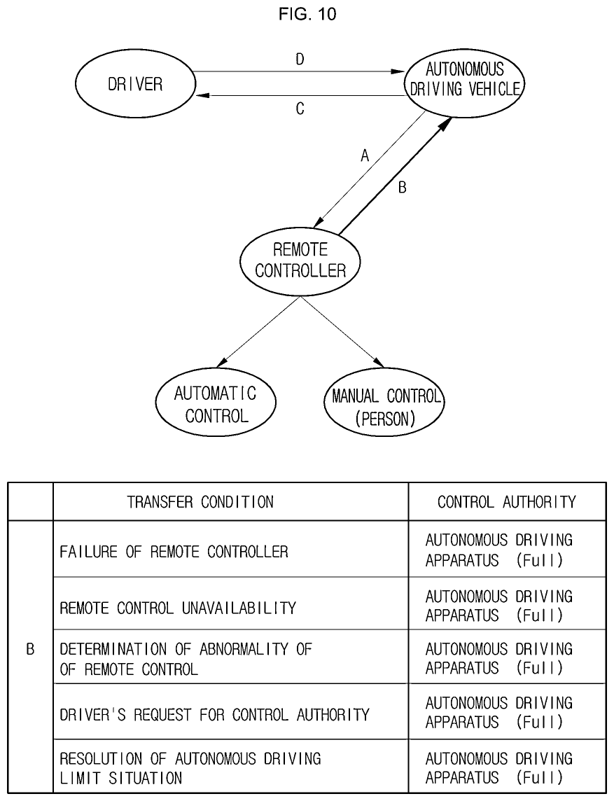

Conversely, as illustrated in FIG. 10, a condition in which the control authority is returned from the remote controller 3 to the vehicle 1 (control authority transfer B) may include the failure of the remote controller 3, the remote control unavailability, the abnormality determination of the remote control, the driver's control authority request, the resolution of the autonomous driving limit situation, etc.

The determination of the above-described condition may be performed by the vehicle 1 or the remote controller 3.

Alternatively, the control authority may be also returned to the vehicle 1 when the driver's abnormal state is resolved or the abnormal driving of the vehicle is resolved.

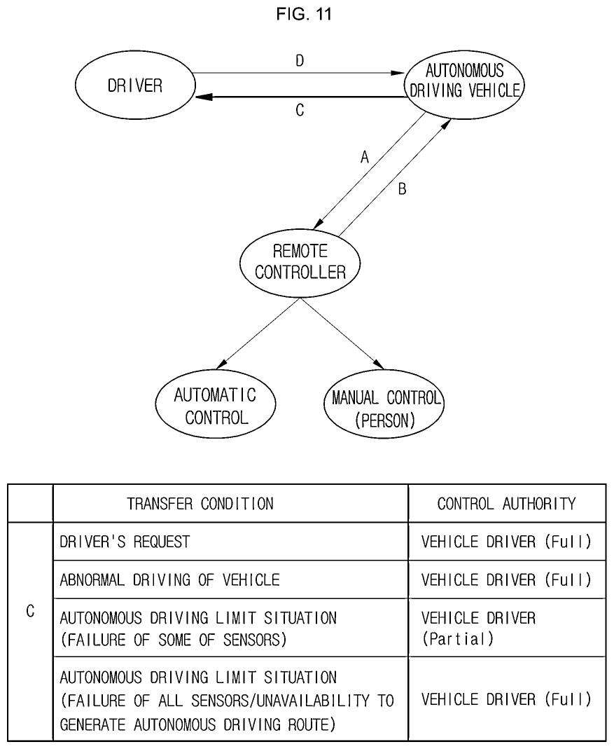

Referring to FIG. 11, a condition in which the control authority is transferred from the vehicle 1, which is performing the autonomous driving, to the driver (control authority transfer C) may include the driver's request, the abnormal driving of the vehicle, the autonomous driving limit situations, etc.

Referring to FIG. 9 together, it can be confirmed that the condition of the control authority transfer from the vehicle 1 to the remote controller 3 and the condition of the control authority transfer from the vehicle 1 to the driver excluding the driver-related conditions are the same. The vehicle 1 may set a priority of the control authority and first transfer a target having a higher priority when a reason to deprive the control authority from the vehicle 1, which is performing the autonomous driving, occurs.

For example, when the driver has a higher priority, the control authority may be first transferred to the driver, and the control authority may be transferred to the remote controller 3 only when there is no response from the driver. When there is no response from the remote controller 3, the vehicle 1 may be stopped and make an emergency call.

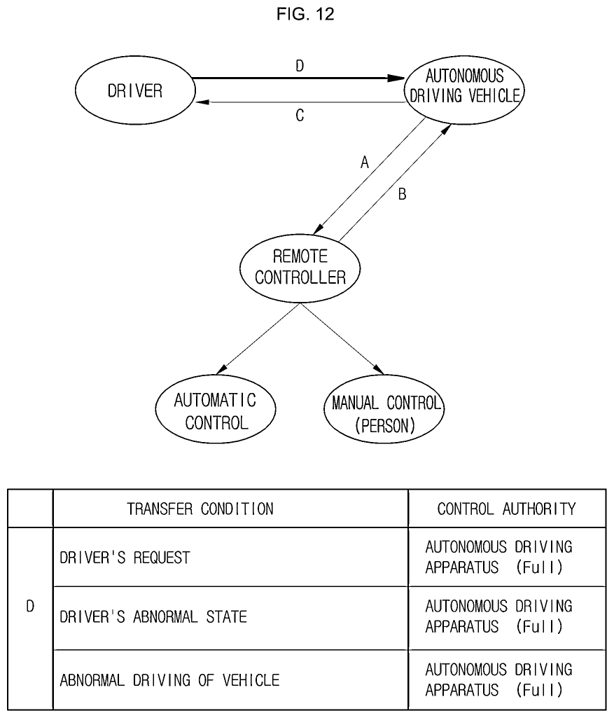

Referring to FIG. 12, the condition in which the control authority is transferred from the driver to the vehicle 1 (control authority transfer D), that is, the condition in which the vehicle 1 enters the autonomous driving mode may include the driver's request, the driver's abnormal state, the abnormal driving of the vehicle, etc. It is assumed that all conditions are situations occurring during the driver's manual driving.

The controller 140 may determine the driver's abnormal state or the abnormal driving of the vehicle based on the output of at least one of the external camera 110, the internal camera 115, the vehicle behavior sensor 90, the radar 120, the LiDAR 130, or the driver sensor 150 during the driver's manual driving and determine that the control authority transfer condition in which the control authority is transferred from the driver to the vehicle 1 is satisfied when at least one of the driver's abnormal state or the abnormal driving of the vehicle occurs or there is the driver's request.

According to the above-described autonomous driving apparatus and autonomous driving method, by actively transferring the control authority of the autonomous vehicle according to various situations related to the autonomous driving, it is possible to increase the reliability and stability of the autonomous driving.

In addition, by including an external remote controller in a transfer target of the control authority, it is also possible to cope with a situation in which the driver's manual driving is impossible.

Meanwhile, the disclosed embodiments may be implemented in the form of a recording medium in which instructions executable by a computer are stored. For example, instructions for performing the above-described autonomous driving control method may be stored in the form of a program code, and when executed by a processor, a program module may be generated to perform operations of the disclosed embodiments. The recording medium may be implemented as a computer-readable recording medium.

The computer-readable recording medium includes any type of recording media in which instructions that can be decoded by a computer are stored. For example, there may be a read only memory (ROM), a random access memory (RAM), a magnetic tape, a magnetic disk, a flash memory, an optical data storage device, etc.

A device-readable storage medium may be provided in the form of a non-transitory storage medium. For example, “non-temporary storage medium” may include a buffer in which data is temporarily stored.

As is apparent from the above description, by appropriately transferring a control authority of a vehicle based on various pieces of information such as a driver's state, a driving state of a vehicle, and an autonomous driving situation, it is possible to increase stability and reliability of the autonomous driving.

As described above, the disclosed embodiments have been described with reference to the accompanying drawings. Those skilled in the art to which the present disclosure pertains will understand that the present disclosure can be carried out in the form different from those of the disclosed embodiments even without changing the technical spirit or essential features of the present disclosure. The disclosed embodiments are illustrative and should not be construed as being limited.

What is claimed is:

1. An autonomous driving apparatus comprising:
an external camera having a field of view around a vehicle and configured to acquire image data;
a radar having a field of sensing around the vehicle and configured to acquire radar data; and
a controller configured to determine whether a control authority transfer condition of the vehicle is satisfied based on at least one of the image data or the radar data during autonomous driving of the vehicle,
wherein the controller is configured to:
determine whether the vehicle normally drives based on at least one of the image data or the radar data;
determine that the control authority transfer condition is satisfied when the driving of the vehicle is in an abnormal state; and
transfer a control authority to a pre-registered remote controller when the control authority transfer condition is satisfied.

2. The autonomous driving apparatus of claim 1, wherein the controller determines whether the vehicle departs from a lane based on the image data, and when the vehicle departs from the lane, determines that the driving of the vehicle is abnormal.

3. The autonomous driving apparatus of claim 1, wherein the controller determines a degree of risk of collision between the vehicle and a nearby vehicle based on at least one of the radar data or the image data, and when the degree of risk of collision exceeds a reference level, determines that the driving of the vehicle is abnormal.

4. The autonomous driving apparatus of claim 1, further comprising a light detection and ranging (LiDAR) having a field of sensing around the vehicle to acquire LiDAR data,
wherein the controller determines a degree of risk of collision between the vehicle and a nearby vehicle based on at least one of the LiDAR data or the image data, and when the degree of risk of collision exceeds a reference level, determines that the driving of the vehicle is abnormal.

5. The autonomous driving apparatus of claim 1, wherein the controller determines whether the vehicle is suddenly steered based on an output of a steering angle sensor provided in the vehicle, and when the vehicle is suddenly steered, determines that the driving of the vehicle is abnormal.

6. The autonomous driving apparatus of claim 1, wherein the controller determines a control authority return condition based on at least one of the image data or the radar data, and when the control authority return condition is satisfied, transfers the control authority from the remote controller to the vehicle.

7. The autonomous driving apparatus of claim 1, wherein the control authority transfer condition further includes at least one of a driver's abnormal state of the vehicle or a limit situation of the autonomous driving.

8. The autonomous driving apparatus of claim 7, wherein the controller determines the driver's abnormal state based on an output of at least one of an internal camera provided in the vehicle to capture the driver or a driver sensor configured to acquire biosignals of the driver.

9. The autonomous driving apparatus of claim 1, wherein the controller transfers the control authority to the pre-registered remote controller when the driving of the vehicle is abnormal and there is no response from the driver of the vehicle.

10. An autonomous driving apparatus comprising:
at least one memory configured to store a program for autonomous driving of a vehicle; and
at least one processor configured to execute the stored program,
wherein the processor is configured to:
determine whether the vehicle normally drives based on at least one of image data acquired by an external camera provided in the vehicle, radar data acquired by a radar provided in the vehicle, or light detection and ranging (LiDAR) data acquired by a LiDAR provided in the vehicle;
determine that a control authority transfer condition of the vehicle is satisfied when the driving of the vehicle is abnormal; and
transfer a control authority to a pre-registered remote controller when the control authority transfer condition is satisfied.

11. The autonomous driving apparatus of claim 10, wherein the processor determines whether the vehicle departs from a lane based on the image data, and when the vehicle departs from the lane, determines that the driving of the vehicle is abnormal.

12. The autonomous driving apparatus of claim 10, wherein the processor determines a degree of risk of collision between the vehicle and a nearby vehicle based on at least one of the radar data, the image data, or the LiDAR data, and when the degree of risk of collision exceeds a reference level, determines that the driving of the vehicle is abnormal.

13. The autonomous driving apparatus of claim 10, wherein the processor determines whether the vehicle is suddenly steered based on an output of a steering angle sensor provided in the vehicle, and when the vehicle is suddenly steered, determines that the driving of the vehicle is abnormal.

14. The autonomous driving apparatus of claim 10, wherein the processor determines a control authority return condition based on at least one of the image data, the LiDAR data, or the radar data, and when the control authority return condition is satisfied, transfers the control authority from the remote controller to the vehicle.

15. The autonomous driving apparatus of claim 10, wherein the control authority transfer condition further includes at least one of a driver's abnormal state of the vehicle or a limit situation of the autonomous driving.

16. The autonomous driving apparatus of claim 15, wherein the controller determines the driver's abnormal state based on an output of at least one of an internal camera provided in the vehicle to capture the driver or a driver sensor configured to acquire biosignals of the driver.

17. An autonomous driving control method comprising:
acquiring image data through an external camera provided in a vehicle;
acquiring radar data through a radar provided in the vehicle;
determining whether the vehicle normally drives based on at least one of the image data or the radar data during autonomous driving of the vehicle;
determining that a control authority transfer condition is satisfied when the driving of the vehicle is abnormal; and
transferring a control authority to a pre-registered remote controller when the control authority transfer condition is satisfied.

18. The autonomous driving control method of claim 17, wherein the determining of whether the vehicle normally drives includes determining whether the vehicle departs from a lane based on the image data and determining that the driving of the vehicle is abnormal when the vehicle departs from the lane.

19. The autonomous driving control method of claim 17, wherein the determining of whether the vehicle normally drives includes determining a degree of risk of collision between the vehicle and a nearby vehicle based on the radar data or the image data and determining that the driving of the vehicle is abnormal when the degree of risk of collision exceeds a reference level.

20. The autonomous driving control method of claim 17, further comprising acquiring light detection and ranging (LiDAR) data through an LiDAR provided in the vehicle,
wherein the determining of whether the vehicle normally drives includes determining a degree of risk of collision between the vehicle and a nearby vehicle based on the LiDAR data or the image data and determining that the driving of the vehicle is abnormal when the degree of risk of collision exceeds a reference level.
